(19) United States
(12) Patent Application Publication
(10) Pub. No.: US 2014/0051804 A1
(43) Pub. Date: Feb. 20, 2014

(54) POLYSILANESILOXANE RESINS FOR USE IN AN ANTIREFLECTIVE COATING

(71) Applicants: Xiaobing Zhou, Midland, MI (US); Eric S. Moyer, Midland, MI (US)

(72) Inventors: Xiaobing Zhou, Midland, MI (US); Eric S. Moyer, Midland, MI (US)

(21) Appl. No.: 14/003,497

(22) PCT Filed: Mar. 8, 2012
(86) PCT No.: PCT/US12/28208

§ 371 Date: Oct. 29, 2013

Related U.S. Application Data
(60) Provisional application No. 61/451,172, filed on Mar. 10, 2011.

(51) Int. Cl. C09D 5/00

(52) U.S. Cl. CPC C09D 5/006
USPC 524/769

(57) ABSTRACT

Polysilanesiloxane copolymers or resins and method of making are provided. The present disclosure further provides a method of applying the polysilanesiloxane copolymers onto a substrate to form a polysilanesiloxane film for use in photolithography (193 nm). The polysilanesiloxane films meet the basic performance criteria expected or desired for use in an antireflection coating (ARC) application,

### FIELD

This disclosure relates generally to polysilane-polysiloxane copolymer resins and their use in electronic devices. More specifically, this disclosure relates to the preparation of polysilanesiloxane resins and a method of using these resins as antireflective coatings in a photolithographic process.

### BACKGROUND

Photolithography (193 nm) is a photo-patterning process routinely used by electronics manufacturers in making leading edge semiconductor chips. In this process, a layer of an antireflective coating (ARC) is deposited underneath a layer of an organic photosensitive material or photoresist. This ARC layer is used to planarize the topography of the wafer substrate in order to allow for the deposition or formation of a uniform photoresist layer. This ARC layer also prevents interference that can result from reflection of the irradiating light beam.

Commercially available antireflective coatings consist of both organic-based and inorganic-based materials. Inorganic ARC materials are usually deposited onto a substrate's surface using a chemical vapor deposition (CVD) process. Thus, although inorganic-based ARC materials normally exhibit etch resistance, they also are subject to the integration disadvantages associated with extreme topography differences or variations. On the other hand, organic ARC materials are conventionally applied using a spin-on process. Organic ARC materials exhibit excellent fill and planarization properties, but suffer from poor etch selectivity with organic photoresists. As a result, a material that offers the combined advantages associated with organic and inorganic ARC is highly desirable.

U.S. Pat. No. 7,270,931 discloses a silicon-based spin-on ARC resin in which oligosilane moieties Siₙ (n=1-15) are grafted onto an organic resin, such as a novolac resin. In these oligosilane moieties, the non-crosslinkable sites of the Siₙ moieties are occupied by organic groups or halogen atoms. These Siₙ moieties, which can improve etch selectivity for the organic ARC resin, are classified as polysilanes.

Another type of silicon-based spin-on ARC resins are polysiloxane-based, or more specifically, polysilsesquioxane-based resins, such as the 4T resins available from Dow Corning Corporation, Midland, Mich. These polysiloxane ARC resins are copolymers having more than one RSiO_{1.5} component in which R is selected as being either hydrogen or a functional organic group. The nature of the R group assists in determining the film properties exhibited by the photoresist. These properties include light absorption at 193 nm wavelength, etch selectivity, hydrophobicity, wetting of substrates, and adhesion to various substrates.

U.S. Pat. No. 7,202,013 and Japanese Publication No. 2005048152(A) describe polysilane-polysiloxane (polysilanesiloxanes) co-polymeric ARC resins. Polysilanesiloxanes represent a class of copolymers that comprise a hybrid of polysilane and polysiloxane units. More specifically, polysilane moieties (Siₙ) are grafted in linear, branched, or cyclic form to polysiloxane backbones present in the copolymeric resins.

U.S. Patent Publication No. 2007/117252 discloses another polysilane-polysiloxane copolymer composition for use as an antireflective coating (ARC). The copolymer is synthesized by the hydrolytic condensation of alkoxydisilanes and other alkoxysilanes. In this manner, the Si₂ repeating units are incorporated into the polysiloxane backbone of the copolymers through Si—O—Si bonding. The Si—Si single bonds function as a chromophore for the absorption of 193 nm light in this ARC.

A more thorough description of the composition, syntheses, properties, and applications associated with conventional polysilanesiloxane copolymers can be found in a manuscript published by Plumb and Atherton in Copolymers Containing Polysiloxane Blocks, Wiley, New York, (1973), pages 305-53 and in an article authored by Chojnowski, et al. and published in Progress in Polymer Science, 28(5), (2003), pages 691-728.

### SUMMARY

In overcoming the enumerated drawbacks and other limitations of the related art, the present disclosure provides polysilanesiloxane copolymers or resins for use in forming an antireflective coating or layer on a substrate, as well as a method of making the same. The present disclosure contemplates the use of such a polysilanesiloxane film in photolithographic (193 nm) process.

The polysilanesiloxane copolymer resins prepared according to the teachings of the present disclosure generally comprise a first component characterized by units of RSiOₐ(OH)_{b}(OR′)_{c}, where the subscripts a, b, and c are numbers greater than or equal to zero having the relationship (2a+b+c)=3; and a second component characterized by units of Si₅Oₓ(OH)_{y}(OR″)_{z}, where the subscripts x, y, and z are numbers greater than or equal to zero having the relationship (2x+y+z)=12. The R group is an organic light-absorbing group, while the R′ and R″ groups are alkyl groups, such as a methyl group, among others. Alternatively, the light-absorbing group absorbs light at a wavelength of about 193 nanometers and can be a phenyl group when desirable.

According to another aspect of the present disclosure, the ratio of the molar fraction for the first component and second component in the polysilanesiloxane copolymer resin is about 1:1. The first component may comprise a hybrid of PhSiOₐ(OH)_{b}(OMe)_{c} units and MeSiOₐ(OH)_{b}(OMe)_{c} units, wherein “Ph” denotes a phenyl group and “Me” denotes a methyl group hereinafter. The molar ratio of PhSiOₐ(OH)_{b}(OMe)_{c}:MeSiOₐ(OH)_{b}(OMe)_{c} units is selected as one between about 4:1 and 1:4. Alternatively, the molar ratio of PhSiOₐ(OH)_{b}(OMe)_{c}:MeSiOₐ(OH)_{b}(OMe)_{c} units is 2:3.

According to another aspect of the present disclosure the polysilanesiloxane copolymer resin comprises a hybrid of T^{Ph}, T^{Me}, and PSSX^{Si5} units according to the formula: T^{Ph}ₘT^{Me}ₙPSSX^{Si5}_{0.5}, where T^{Ph}ₘ represents units of PhSiOₐ(OH)_{b}(OMe)_{c} with (2a+b+c)=3 and m being a molar fraction that ranges between 0.1 and 0.4; T^{Me}ₙ represents units of MeSiO_{d}(OH)ₑ(OMe)_{f} with the subscripts d, e, and f being numbers greater than or equal to zero, such that (2d+e+f)=3 and n being a molar fraction that ranges between 0.4 and 0.1, such that (m+n)=0.5; and PSSX^{Si5}_{0.5} represents units of Si₅Oₓ(OH)_{y}(OMe)_{z} with (2x+y+z)=12 and a molar fraction of about 0.5. Alternatively, the T^{Ph} molar fraction m is about 0.2 and the T^{Me} molar fraction n is about 0.3.

According to yet another aspect of the present disclosure, an antireflective coating is applied to a substrate for use in photolithography, the antireflective coating comprising the polysilanesiloxane copolymer resin as described above and herein. The antireflective coating is capable of absorbing light at a wavelength of about 193 nanometers.

According to another aspect of the present disclosure a method of preparing polysilanesiloxane copolymer resins for use in forming an antireflective coating on a substrate is provided. This method generally comprises the steps of providing a predetermined amount of at least one trimethoxysilane and providing a predetermined amount of permethoxyneopentasilane. The trimethoxysilane and the permethoxyneopentasilane are mixed together in an alcohol solvent containing a predetermined amount of acidified water. The trimethoxysilane and permethoxyneopentasilane are then allowed to hydrolyze to form a polysilanesiloxane copolymer resin comprising T^{Ph}, T^{Me}, and PSSX^{Si5} units according to the formula described above and herein. The alchohol solvent is exchanged with a film forming solvent to form a resin solution. Finally, the resin solution is concentrated until the solution comprises about 10 wt. % resin.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a graphical representation of a method of making a polysilanesiloxane copolymer or resin according to one aspect of the present disclosure; and

FIG. 2 is a graphical representation of the spectrum measured by gel permeation chromatography (GPC) for PSSX copolymers prepared according to one aspect of the present disclosure.

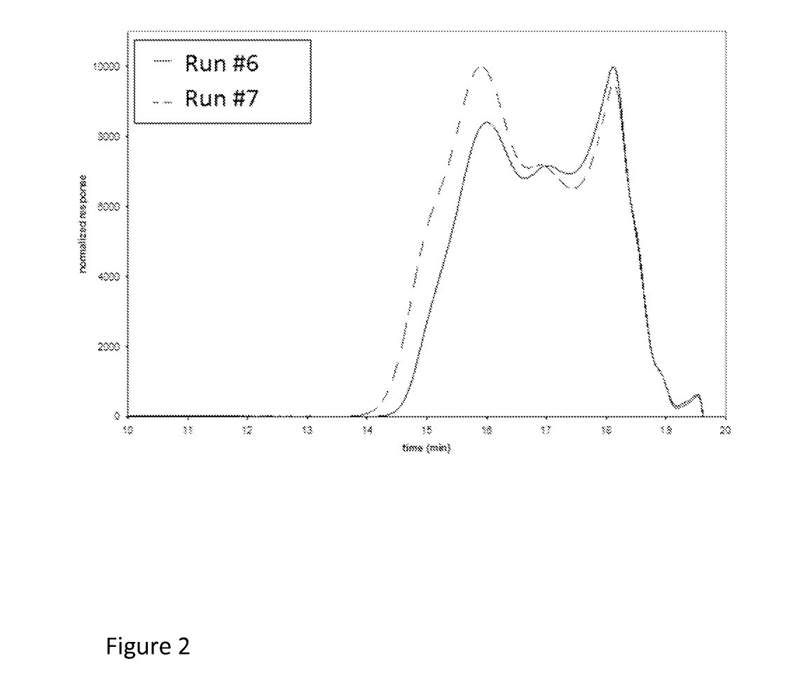

### DETAILED DESCRIPTION

The following description is merely exemplary in nature and is in no way intended to limit the present disclosure or its application or uses. It should be understood that throughout the description and drawings, corresponding reference numerals indicate like or corresponding parts and features.

The present disclosure generally provides polysilanesiloxane copolymers or resins, as well as a method of making the same. The present disclosure further provides a method of applying the polysilanesiloxane copolymers onto a substrate to form a polysilanesiloxane film for use in photolithography (193 nm). The polysilanesiloxane films meet the basic performance criteria expected or desired for use in an antireflection coating (ARC) application, including but not limited to, absorption of 193 nm wavelength light; resistance to photoresist developers, such as tetramethylammonium hydroxide (TMAH); thermal stability under photoresist processing conditions; and selective removal with respect to organic photoresists.

According to one aspect of the present disclosure, oligomeric silane repeating units Siₙ are cross-linked into a polysiloxane backbone through Si—O—Si bonding. The Siₙ units effectively raise silicon content of the resins. High silicon content is desirable for forming an ARC layer that is chemically distinguishable from organic photoresists. The silane repeating units (Siₙ) is preferably Si₅.

By itself, the silane repeating unit has no noticeable absorption at 193 nm wavelength. However, the silane repeating unit can be used in conjunction with a chromophore that absorbs light at this wavelength. Such a chromophore can be incorporated into the polysilanesiloxane resins through the use of RSiO_{1.5} units, where R is an organic light-absorbing group. The amount of the chromophore that is incorporated into the resin depends upon the magnitude of the desired or targeted extinction coefficient.

The polysilanesiloxane copolymer resins of the present disclosure generally comprise a first component characterized by units of RSiOₐ(OH)_{b}(OR′)_{c}, where the subscripts a, b, and c are numbers greater than or equal to zero having the relationship (2a+b+c)=3; and a second component characterized by units of Si₅Oₓ(OH)_{y}(OR″)_{z}, where the subscripts x, y, and z are numbers greater than or equal to zero having the relationship (2x+y+z)=12. The R group is an organic light-absorbing group, while the R′ and R″ groups are alkyl groups, such as a methyl group, among others. Alternatively, the light-absorbing group absorbs light at a wavelength of about 193 nanometers and can be a phenyl group when desirable.

According to another aspect of the present disclosure, the ratio of the molar fraction for the first component and second component in the polysilanesiloxane copolymer resin is about 1:1. The first component may comprise a hybrid of PhSiOₐ(OH)_{b}(OMe)_{c} units and MeSiOₐ(OH)_{b}(OMe)_{c} units, wherein “Ph” denotes a phenyl group and “Me” denotes a methyl group hereinafter. The molar ratio of PhSiOₐ(OH)_{b}(OMe)_{c}:MeSiOₐ(OH)_{b}(OMe)_{c} units is selected as one between about 4:1 and 1:4. Alternatively, the molar ratio of PhSiOₐ(OH)_{b}(OMe)_{c}:MeSiOₐ(OH)_{b}(OMe)_{c} units is 2:3.

According to another aspect of the present disclosure, the polysilanesiloxane resins are made by the co-hydrolytic condensation of trimethoxysilanes RSi(OMe)₃, and permethoxyneopentasilane Si[Si(OMe)₃]₄. Generally, the method of forming the polysilanesiloxane resin comprises: a) hydrolysis of a premixed and predetermined amount of trimethoxysilanes and permethoxyneopentasilane in an alcohol solvent, such as ethanol, in the presence of an excess amount of acidified water; and b) exchange of the alcohol solvent with propylene glycol monomethyl ether acetate (PGMEA); followed by concentrating the resin solution to about a 10 wt. % solids content.

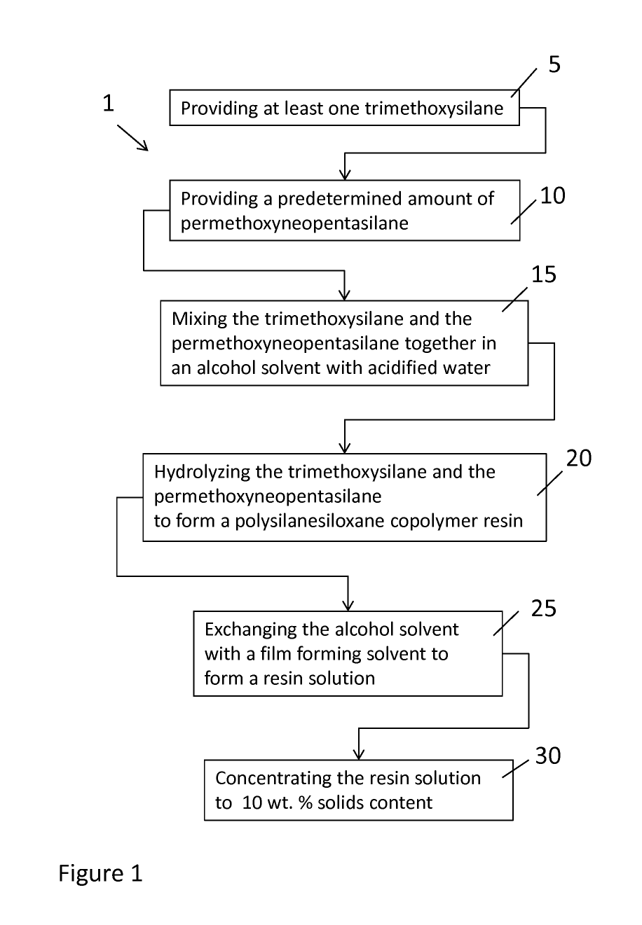

Referring now to FIG. 1, the method 1 comprises providing (5) a predetermined amount of at least one trimethoxysilane and providing (10) a predetermined amount of a permethoxyneopentasilane. The trimethoxysilane(s) and the permethoxyneopentasilane are mixed (15) together in an alcohol solvent having an excess amount of acidified water. The trimethoxysilane(s) and permethoxyneopentasilane are hydrolyzed (20) to form a polysilanesiloxane copolymer resin. The alcohol solvent is then exchanged (25) with a film-forming solvent to form a resin solution. Finally, the resin solution is concentrated (30) to a 10 wt. % solids content.

Several polysilanesiloxane resins (Run #'s 1-7) with and without a chromophore were prepared according to the method described above. The short-hand nomenclature used to describe each of these resins (Run #'s 1-7) is illustrated through the use of the following specific example. The resin formed in Run #5 is described as T^{Ph}_{0.2}T^{Me}_{0.3}PSSX^{Si5}_{0.5} in which the T^{Ph} component represents the hydrolysis product of PhSi(OMe)₃, the T^{Me} component represents the hydrolysis product of MeSi(OMe)₃, and the PSSX^{Si5} component represents the hydrolysis product of Si[Si(OMe)₃]₄. The subscripts of about 0.2, 0.3, and 0.5 used in conjunction with the T^{Ph}, T^{Me}, and PSSX^{Si5} components, respectively, indicate the molar fraction of that component in the overall polysilanesiloxane resin. The polysilanesiloxane resins made according to the teachings of the present disclosure contain a high level of silanol functionality, as well as some residual SiOMe groups. In order to increase shelf-life and long-term stability, it may be desirable to store these resins at a low temperature.

According to another aspect of the present disclosure the polysilanesiloxane copolymer resin comprises a hybrid of T^{Ph}, T^{Me}, and PSSX^{Si5} units according to the formula: T^{Ph}ₘT^{Me}ₙPSSX^{Si5}_{0.5}, where T^{Ph}ₘ represents units of PhSiOₐ(OH)_{b}(OMe)_{c} with (2a+b+c)=3 and m being a molar fraction that ranges between 0.1 and 0.4; T^{Me}ₙ represents units of MeSiO_{d}(OH)ₑ(OMe)_{f} with the subscripts d, e, and f being numbers greater than or equal to zero, such that (2d+e+f)=3 and n being a molar fraction that ranges between 0.4 and 0.1, such that (m+n)=0.5; and PSSX^{Si5}_{0.5} represents units of Si₅Oₓ(OH)_{y}(OMe)_{z} with (2x+y+z)=12 and a molar fraction of about 0.5. Alternatively, the T^{Ph} molar fraction m is about 0.2 and the T^{Me} molar fraction n is about 0.3.

The polysilanesiloxane resins formed herein can be spin deposited to form high quality films on the surface of a wafer or other substrate using standard spin deposition profiles well known to one skilled-in-the-art of electronic materials. One use of such a film is as an antireflective coating applied to a substrate during photolithography. Such an antireflective coating is capable of absorbing light at a wavelength of about 193 nanometers. The films can then be cured by baking at an elevated temperature for a predetermined amount of time. For example, the films can be baked on a hotplate at 250° C. for 1 minute.

The mechanical, optical, and chemical properties of the cured films can be tested by any techniques known in the art. Examples of different basic film properties include, but are not limited to, contact angle, surface energy, refractive index (N value) at 193 nm wavelength, extinction coefficient (K value) at 193 nm wavelength, and loss in film thickness caused by exposure to PGMEA or tetramethylammonium hydroxide (TMAH). The measured properties for the polysilanesiloxane resins (Runs 1-7) prepared herein are provided below in Table 1.

TABLE 1

| | | | | | Smoke | | | | |
|---|---|---|---|---|---|---|---|---|---|
| | | | | Surface | on | N | K | | |
| | | Silicon | | Energy | HP | Value | Value | PGMEA | TMAH |
| Run | Resin | Content | Contact | (dyne/ | Yes/ | @192.547 | | Loss | Loss |
| # | Description | (wt. %) | Angle | cm) | no | nm | | (Å) | (Å) |
| 1 | PSSX^{Si5} | 59 | 80.5 | 32.5 | n | 1.545 | 0.012 | 1 | 10 |
| 2 | T^{Me}_{0.5}PSSX^{Si5}_{0.5} | 55 | 85 | 30.6 | n | 1.533 | 0.009 | 1 | 2 |
| 3 | T^{Ph}_{0.5}PSSX^{Si5}_{0.5} | 46 | 85 | 33.8 | y | 1.762 | 0.176 | 3 | 121 |
| 4 | T^{Ph}_{0.1}T^{Me}_{0.4}PSSX^{Si5}_{0.5} | 53 | 85 | 31.1 | n | 1.606 | 0.105 | 1 | 1 |
| 5 | T^{Ph}_{0.2}T^{Me}_{0.3}PSSX^{Si5}_{0.5} | 51 | 71 | 38.9 | n | 1.687 | 0.194 | 2 | 2 |
| 6 | T^{Ph}_{0.2}T^{Me}_{0.3}PSSX^{Si5}_{0.5} | 51 | 85 | 32.9 | y | 1.657 | 0.18 | 3 | 5 |
| 7 | T^{Ph}_{0.2}T^{Me}_{0.3}PSSX^{Si5}_{0.5} | 51 | 85 | 32.9 | y | 1.668 | 0.188 | 2 | 3 |

The resin of Run #1, which is described as PSSX^{Si5}, was prepared using only Si[Si(OMe)₃]₄. The film resulting from this resin exhibits a very low K value of 0.012. This low K value indicates that the Si₅ units have no significant absorption of light at a wavelength of 193 nm. A comparably low K value of 0.009 is also observed for the resin in Run #2 prepared using a 1:1 mix of MeSi(OMe)₃ and Si[Si(OMe)₃]₄. Even though these two resins gave low target film losses—less than 10 Å—in PGMEA and TMAH, the resulting resin is not a suitable candidate for a 193 nm antireflection coating (ARC) due to insufficient light absorption at this wavelength.

A phenyl group is an effective chromophore for the absorption of light at a wavelength of 193 nm. When a T^{Ph} component is incorporated into the PSSX resin, the K values exhibited by the resin increase. For example, the polysilanesiloxane resin in Run #3 was made using a 1:1 mix of PhSi(OMe)₃ and Si[Si(OMe)₃]₄. This resin exhibits a good K value of 0.176, but also an unacceptable high film loss of 121 Å upon exposure to TMAH. In order to meet or surpass the film performance required and/or desired for use in photolithography, a T^{Me} component is added to the T^{Ph} and PSSX components in the resin. As a result, the resin prepared in Run #4, which is described as T^{Ph}_{0.1}T^{Me}_{0.4}PSSX^{Si5}_{0.5}, exhibits a good N value and low film losses upon exposure to both PGMEA and TMAH. In Run #4, the K value of 0.105 is also acceptable, with possible further improvement desirable.

A slight reduction in average molar fraction of the T^{Me} component from 0.4 to 0.3 results in a resin (Run #'s 5-7) that exhibits excellent overall film properties. The excellent performance of the film comprising the T^{Ph}_{0.2}T^{Me}_{0.3}PSSX^{Si5}_{0.5} resin was verified to be consistent with a total of three runs (Run #'s 5-7) being made and tested. The resins prepared and tested in Run #'s 5-7 have a calculated silicon content of 51 wt. %, which is more than 10 wt. % higher than the silicon content found in conventional silicon-based ARC resins. Polysilanesiloxane resins that comprise Si₅ repeating units to effectively raise the silicon content of the resin and a chromophore for absorbing light at a wavelength of 193 nm are acceptable for use in an antireflective coating.

The following specific examples are given to illustrate the invention and should not be construed to limit the scope of the invention.

### Example 1

### Preparation of Polysilansiloxane Resins

This example demonstrates the method used to prepare the polysilanesiloxane resins according to the teachings of the present disclosure. This method is described for the preparation of the polysilanesiloxane resin of Run #5. One skilled-in-the-art will understand that the same method can be utilized to prepare other polysilanesiloxane resins, such as those described in Run #'s 1-4, 6, and 7, without exceeding the scope of the present disclosure.

In Run #5, a total of 2.64 g (5.15 mmol) of Si[Si(OMe)₃]₄ was dissolved in 13.85 grams of ethanol along with 0.408 grams (2.06 mmol) of PhSi(OMe)₃ and 0.421 grams (3.09 mmol) of MeSi(OMe)₃. Then a total of 2.08 grams of 0.1 N HCl was added slowly to the solution at a SiOMe:H₂O molar ratio of 1:1.5. After stirring at room temperature for 3 hours, 30.40 grams of PGMEA was added. The alcohol solvent present in the resin solution was partially removed by vacuum until the resin solution weighed 16.89 g, which corresponds to about a 10 wt. % solids content.

The molecular weight distribution of the 10 wt. % resin was measured by gel permeation chromatography (GPC) as shown in FIG. 1 for Run #'s 6 and 7. The polysilanesiloxane resin (Run #'s 5-7) exhibits an average number average molecular weight (Me) of about 1600 amu and an average weight average molecular weight (M_{w}) of about 5900 amu. Since the resin is rich in silanol concentration, it may optionally be stored in a freezer at, for example, −15° C., where it will remain stable for an extended period of time, i.e., exhibit a long shelf-life.

A person skilled in the art will recognize that the measurements described are standard measurements that can be obtained by a variety of different test methods. The test methods described in the examples represents only one available method to obtain each of the required measurements.

The foregoing description of various embodiments of the present disclosure has been presented for purposes of illustration and description. It is not intended to be exhaustive or to limit the present disclosure to the precise embodiments disclosed. Numerous modifications or variations are possible in light of the above teachings. The embodiments discussed were chosen and described to provide the best illustration of the principles included in the present disclosure and its practical application to thereby enable one of ordinary skill in the art to utilize the teachings of the present disclosure in various embodiments and with various modifications as are suited to the particular use contemplated. All such modifications and variations are within the scope of the present disclosure as determined by the appended claims when interpreted in accordance with the breadth to which they are fairly, legally, and equitably entitled.

What is claimed is:

1. A polysilanesiloxane copolymer resin for use in forming an antireflective coating, the polysilanesiloxane copolymer resin comprising:
a first component defined by units of RSiOₐ(OH)_{b}(OR′)_{c}, where the subscripts a, b, and c are numbers greater than or equal to zero, such that (2a+b+c)=3; wherein R is an organic light-absorbing group and R′ is an alkyl group; and
a second component defined by units of Si₅Oₓ(OH)_{y}(OR″)_{z}, where the subscripts x, y, and z are numbers greater than or equal to zero, such that (2x+y+z)=12; wherein R″ is an alkyl group.

2. The polysilanesiloxane copolymer resin of claim 1, wherein the R group is one selected from a phenyl group and a methyl group.

3. The polysilanesiloxane copolymer resin of claim 1, wherein the R group absorbs light at a wavelength of about 193 nanometers.

4. The polysilanesiloxane copolymer resin of claim 1, wherein at least one of the R′ and R″groups is a methyl group.

5. The polysilanesiloxane copolymer resin of claim 1, wherein the ratio of the molar fraction for the first component and second component in the polysilanesiloxane copolymer resin is about 1:1.

6. The polysilanesiloxane copolymer resin of claim 1, wherein the first component is comprised of a hybrid of PhSiOₐ(OH)_{b}(OMe)_{c} and MeSiOₐ(OH)_{b}(OMe)_{c} units.

7. The polysilanesiloxane copolymer resin of claim 6, wherein the molar ratio of PhSiOₐ(OH)_{b}(OMe)_{c}:MeSiOₐ(OH)_{b}(OMe)_{c} units is selected as one between about 4:1 and 1:4.

8. The polysilanesiloxane copolymer resin of claim 7, wherein the molar ratio of PhSiOₐ(OH)_{b}(OMe)_{c}:MeSiOₐ(OH)_{b}(OMe)_{c} units is 2:3.

9. A polysilanesiloxane copolymer resin for use in forming an antireflective coating, the polysilanesiloxane copolymer resin comprising T^{Ph}, T^{Me}, and PSSX^{Si5} units according to the formula:
T^{Ph}ₘT^{Me}ₙPSSX^{Si5}_{0.5}
wherein T^{Ph}ₘ represents units of PhSiOₐ(OH)_{b}(OMe)_{c} with the subscripts a, b, and c being numbers greater than or equal to zero, such that (2a+b+c)=3 and m is a molar fraction that ranges between 0.1 and 0.4; T^{Me}ₙ represents units of MeSiO_{d}(OH)ₑ(OMe)_{f} with the subscripts d, e, and f being numbers greater than or equal to zero, such that (2d+e+f)=3 and n is a molar fraction that ranges between 0.4 and 0.1, such that (m+n)=0.5; and PSSX^{Si5}_{0.5} represents units of Si₅Oₓ(OH)_{y}(OMe)_{z} with the subscripts x, y, and z being numbers greater than or equal to zero, such that (2x+y+z)=12 and a weight fraction of about 0.5;
wherein Ph is a phenyl group and Me is a methyl group.

10. The polysilanesiloxane copolymer resin of claim 9, wherein m is about 0.2 and n is about 0.3.

11. An antireflective coating applied to a substrate for use in photolithography, the antireflective coating being comprised of the polysilanesiloxane copolymer resin of claim 1.

12. The antireflective coating of claim 11, wherein the antireflective coating absorbs light at a wavelength of about 193 nanometers.

13. A method of preparing a polysilanesiloxane copolymer resin for use in forming an antireflective coating on a substrate, the method comprising the steps of:
providing a predetermined amount of at least one trimethoxysilane;
providing a predetermined amount of permethoxyneopentasilane;
mixing the trimethoxysilane and the permethoxyneopentasilane together in an alcohol solvent; the alcohol solvent containing a predetermined amount of acidified water;
allowing the trimethoxysilane and permethoxyneopentasilane to hydrolyze to form a polysilanesiloxane copolymer resin comprising T^{Ph}, T^{Me}, and PSSX^{Si5} units according to the formula:
T^{Ph}ₘT^{Me}ₙPSSX^{Si5}_{0.5}
wherein T^{Ph}ₘ represents units of PhSiOₐ(OH)_{b}(OMe)_{c} with the subscripts a, b, and c being numbers greater than or equal to zero, such that (2a+b+c)=3 and m being a molar fraction that ranges between 0.1 and 0.4; T^{Me}ₙ represents units of MeSiO_{d}(OH)ₑ(OMe)_{f} with the subscripts d, e, and f being numbers greater than or equal to zero, such that (2d+e+f)=3 and n being a molar fraction that ranges between 0.4 and 0.1, such that (m+n)=0.5; and PSSX^{Si5}_{0.5} represents units of Si₅Oₓ(OH)_{y}(OMe)_{z} with the subscripts x, y, and z being numbers greater than or equal to zero, such that (2x+y+z)=12 and a molar fraction of about 0.5; and wherein Ph is a phenyl group and Me is a methyl group;
exchanging the alcohol solvent with a film forming solvent to form a resin solution; and
concentrating the resin solution until the solution comprises about 10 wt. % resin.

14. The method according to claim 14, wherein the step of hydrolyzing the trimethoxysilane and permethoxyneopentasilane form a polysilanesiloxane copolymer resin having a T^{Ph} molar fraction m of about 0.2 and a T^{Me} molar fraction n of about 0.3.
